(19) United States
(12) Patent Application Publication
(10) Pub. No.: US 2026/0058821 A1
(43) Pub. Date: Feb. 26, 2026

(54) ELECTRONIC DEVICE REGISTRATION AND ATTESTATION

(71) Applicant: HEWLETT PACKARD ENTERPRISE DEVELOPMENT LP, Spring, TX (US)

(72) Inventors: Isaac John Matthews, Bristol (GB); Jean Snyman, Bristol (GB); Supreshna Gurung, Bristol (GB); Nigel John Edwards, Bristol (GB); Timothy J. Pletcher, Spring, TX (US)

(21) Appl. No.: 18/809,663

(22) Filed: Aug. 20, 2024

(51) Int. Cl. H04L 9/32; H04L 9/08

(52) U.S. Cl. CPC H04L 9/3247; H04L 9/0825; H04L 9/0866; H04L 9/3263; H04L 9/3271

(57) ABSTRACT

In some examples, an electronic device downloads an attestation agent from an open-source distribution system, and initiates a registration process of the electronic device with an attestation server. The registration process includes sending, by the attestation agent in the electronic device, a cryptographic device identity for receipt by the attestation server, and receiving, by the attestation agent, an indication of registration of the electronic device based on the attestation server verifying the cryptographic device identity.

### BACKGROUND

Multiple electronic devices can operate in a computing environment, such as a workplace environment of an organization, a data center, a cloud environment, a home, or any other type of computing environment. Attackers may seek to access the computing environment, either by connecting an unauthorized electronic device to a network of the computing environment, or by installing an unauthorized program in an electronic device already connected in the computing environment.

### BRIEF DESCRIPTION OF THE DRAWINGS

Some implementations of the present disclosure are described with respect to the following figures.

FIG. 1 is a block diagram of a computing environment including an electronic device, an attestation server, and a shim system between the electronic device and the attestation server, in accordance with some examples.

FIG. 2 is a flow diagram of a registration workflow, according to some examples.

FIG. 3 is a flow diagram of an authentication workflow, according to some examples.

FIG. 4 is a flow diagram of an attestation workflow, according to some examples.

FIG. 5 is a block diagram of an electronic device according to some examples.

FIG. 6 is a block diagram of a shim system according to some examples.

FIG. 7 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Attestation is performed of an electronic device to ensure an integrity of components (e.g., an operating system (OS) kernel, firmware, and/or other machine-readable instructions) of the electronic device. In some cases, the attestation can be performed using proprietary attestation software downloaded to the electronic device. “Proprietary” attestation software refers to attestation software developed by a vendor, where access to the source code of the attestation software is controlled by the vendor and may not be available to customers of the vendor. Several issues are associated with the use of proprietary attestation software. Some customers may not be comfortable downloading proprietary attestation software that the customers are unable to inspect. Further, customers may have to set up a patch process to download updates of the proprietary attestation software. If the patch process is not set up properly, missing updates of the proprietary attestation software may raise security issues in which electronic devices that have been tampered with are not detected and are allowed to continue to operate in a computing environment.

In accordance with some implementations of the present disclosure, an electronic device is able to download an attestation agent from an open-source distribution system. The attestation agent is used to perform attestation of the electronic device. An open-source distribution system refers to a system by which publicly available program code can be obtained by any requester to make use of the program code in an electronic device of the requester. The open-source distribution system makes source code of the attestation agent available for inspection. In some examples, the open-source distribution system includes a package manager that is able to automatically identify any dependent components that the attestation agent relies on for operation. The dependent components can include software components of a software library, or any other component that is invoked by the attestation agent to perform operations of the attestation agent.

Also, the open-source distribution system may implement an automatic patch process that automatically and reliably updates the attestation agent as a vendor of the attestation agent releases patch updates. The attestation agent can initiate a registration process of the electronic device with an attestation server. The registration process includes sending, by the attestation agent in the electronic device, a cryptographic device identity to the attestation server, and receiving, by the attestation agent, an indication of registration of the electronic device sent by the attestation server responsive to the attestation server verifying the cryptographic device identity. In some examples, in response to receiving the cryptographic device identity from the attestation agent, the attestation server can send a challenge to the electronic device responsive to the attestation server verifying the cryptographic device identity. Upon receiving the challenge, the attestation agent in the electronic device sends, to the attestation server, a challenge response signed with a private key of the cryptographic device identity.

An example of the cryptographic device identity is a Device Identity (DevID) certificate, such as an Initial DevID (IDevID) certificate installed in a device (including the security module and the processor module) at the time of manufacture of the device. Another example of the cryptographic device identity is a Local DevID (LDevID) certificate generated by a customer of the device. DevIDs are explained further in Institute of Electrical and Electronics Engineers (IEEE) 802.1AR Secure Device Identity standard.

A registration of an electronic device with the attestation server allows the attestation server to verify the cryptographic device identity and issue a cryptographic machine identity used for establishing a secure connection with the attestation server for performing attestation of the electronic device. An example of the cryptographic machine identity is a Secure Production Identity Framework for Everyone (SPIFFE) Verifiable Identity Document (SVID) certificate, which is an X.509 identity certificate according to the X.509 Public Key Infrastructure (PKI) standard. SPIFFE is a set of open-source standards for securely identifying and authenticating systems. In other examples, any other type of identity can be assigned to the electronic device for the purpose of establishing a secure connection with the attestation server to perform attestation of the electronic device.

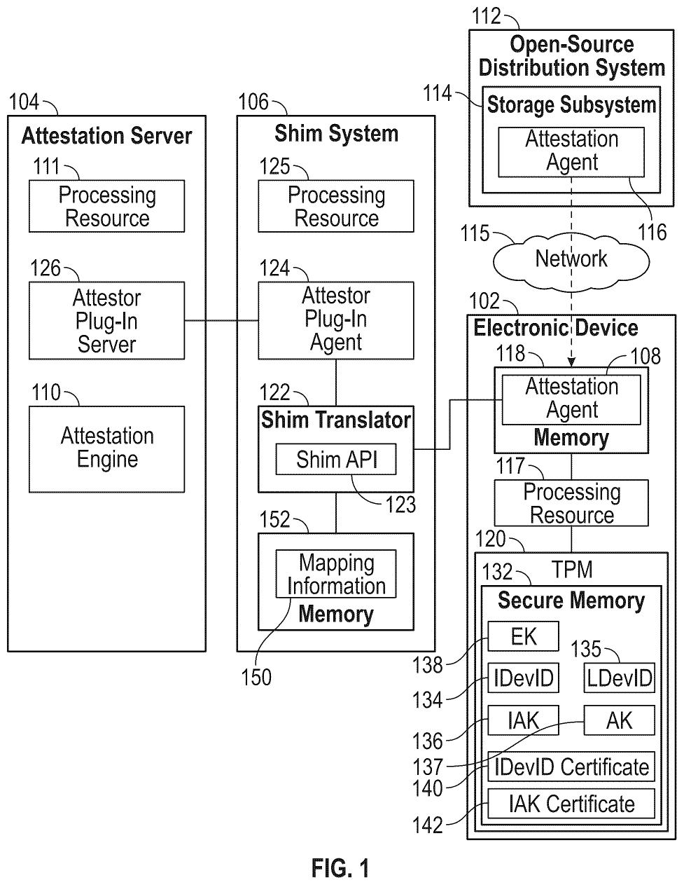

FIG. 1 is a block diagram of an example arrangement that includes an electronic device 102 that is to be attested by an attestation server 104. In some examples, a shim system 106 is provided between the electronic device 102 and the attestation server 104, in cases where an attestation agent 108 running in the electronic device 102 operates according to a first attestation protocol, and an attestation engine 110 in the attestation server 104 operates according to a second attestation protocol that is different from the first attestation protocol. For example, the first attestation protocol may be an open-source protocol, such as the Keylime protocol. The Keylime protocol is provided by the Cloud Native Computing Foundation (CNCF), and supports a remote boot attestation and runtime integrity measurement system. Other examples of open-source attestation protocols include Project VERAISON (VERificAtion of atteStatiON) and Host Integrity at Runtime and Start-up (HIRS). Although depicted as two separate systems, the shim system 106 and the attestation server 104 can be implemented as a single system.

If the attestation agent 108 operates according to the Keylime protocol, then the attestation agent 108 is a Keylime attestation agent. Typically, a Keylime attestation agent interacts with a Keylime registrar and verifier for the purposes of registering an electronic device and performing attestation of the electronic device. In some examples of the present disclosure, instead of using a Keylime registrar and verifier, registration and attestation are performed using the attestation engine 110 that operates according to the second attestation protocol different from the Keylime protocol.

The second attestation protocol used by the attestation engine 110 may be a proprietary attestation protocol associated with an operator of the attestation server 104. An example of a proprietary attestation protocol used by the attestation engine 110 is the Project Aurora protocol from Hewlett Packard Enterprise. In other examples, the attestation engine 110 may operate according to a standardized or open-source attestation protocol for performing attestations of electronic devices, such as those described in Reference Interaction Models for Remote Attestation Procedures, draft-ietf-rats-reference-interaction-models-11, and Using Attestation in Transport Layer Security (TLS) and Datagram Transport Layer Security (DTLS), draft-fossati-tls-attestation-07.

The attestation agent 108 includes machine-readable instructions executable by a processing resource 117 of the electronic device 102. The attestation engine 110 includes machine-readable instructions executable by a processing resource 111 of the attestation server 104.

Although just one electronic device is depicted in FIG. 1, in other examples, there may be multiple electronic devices for which attestation is to be performed by the attestation server 104.

The shim system 106 includes a shim translator 122 that can translate between messages of the first attestation protocol supported by the attestation agent 108 and messages of the second attestation protocol supported by the attestation server 104. In other examples, the attestation engine 110 can operate according to the same attestation protocol (e.g., the Keylime protocol) as the attestation agent 108 in the electronic device 102. For example, the attestation engine 110 may include a Keylime registrar and verifier. In examples where the attestation agent 108 and the attestation engine 110 use the same attestation protocol, translations between messages of the attestation agent 108 and messages of the attestation engine 110 do not have to be performed.

In some examples of the present disclosure, the electronic device 102 can download, over a network 115, the attestation agent 108 from an open-source distribution system 112. The open-source distribution system 112 may be a cloud-based system, a web server system, or any other type of system including one or more computers accessible over the network 115. The open-source distribution system 112 includes a storage subsystem 114 that stores an attestation agent 116. The attestation agent 116 in the storage subsystem 114 of the open-source distribution system 112 is downloaded to the electronic device 102 as the attestation agent 108. The attestation agent 108 is stored in a memory 118 of the electronic device 102.

The electronic device 102 also includes a trusted platform module (TPM) 120. The TPM 120 is an example of a security processor (also referred to as a security cryptoprocessor) that can perform various hardware-based, security functions in the electronic device 102. In other examples, the TPM 120 may be implemented in software, such as in the form of a virtual TPM (which is an example of a virtual security processor). The TPM 120 functions as a root of trust in addition to support for cryptographic functionalities. The security functions of the TPM 120 can include key and certificate management and generation. For example, the TPM 120 can generate cryptographic keys used in security operations, where a cryptographic key can include a public-private key pair including a public key and the associated private key.

The shim translator 122 in the shim system 106 includes a shim application programming interface (API) 123 that is accessible by the attestation agent 108 in the electronic device 102 to initiate registration, authentication, and attestation workflows. The shim API 123 includes various routines that can be called by the attestation agent 108. In other examples, instead of using an API, the shim translator 122 can include a web service, a library, or any other type of service accessible by the attestation agent 108.

In some examples, the shim system 106 further includes an attestor plug-in agent 124. In some examples, the attestor plug-in agent 124 operates according to the SPIFFE standards. The shim translator 122 and the attestor plug-in agent 124 include machine-readable instructions executable by a processing resource 125 of the shim system 106.

The attestor plug-in agent 124 in the shim system 106 interacts with an attestor plug-in server 126 in the attestation server 104. The attestor plug-in server 126 includes machine-readable instructions executable by the processing resource 111 of the attestation server 104. A “plug-in” module, such as the agent 124 or the server 126, refers to a module that can be coupled to a program without modifying the program. The program can be extended with the functionality of the plug-in module without having to re-compile or re-interpret the program. For example, the attestation engine 110 in the attestation server 104 can be extended with the functionality of the attestor plug-in server 126, and the shim translator 122 in the shim system 106 can be extended with the functionality of the attestor plug-in agent 124. The reason for using plug-in modules is to simplify implementation of the shim translator 122 and the attestation engine 110, since functionalities supported by the attestor plug-in agent 124 and the attestor plug-in server 126 do not have to be configured into the shim translator 122 and the attestation engine 110, respectively.

Although reference is made to use of the attestor plug-in agent 124 and the attestor plug-in server 126, in other examples, the functionalities of the attestor plug-in agent 124 and the attestor plug-in server 126 can be provided by other types of modules that can be invoked in the shim translator 122 and the attestation server 104, respectively, to perform requested functionalities. In further examples, the functionalities of the attestor plug-in agent 124 and the attestor plug-in server 126 can be configured into the shim translator 122 and the attestation server 104, respectively. In the latter examples, the attestor plug-in agent 124 and the attestor plug-in server 126 are omitted. In additional examples, the functionalities of the attestor plug-in agent 124 may be implemented with a module loaded by the attestation agent 108 in the electronic device 102, and/or the functionalities of the attestor plug-in server 126 may be implemented with a module loaded by the attestation server 104.

In an example, the attestor plug-in agent 124 and the attestor plug-in server 126 can be implemented with a SPIFFE runtime environment (SPIRE) agent and a SPIRE server, respectively. The SPIRE agent and SPIRE server are open-source tools that provide an implementation of SPIFFE, and perform node and workload attestation to securely issue a cryptographic machine identity according to SPIFFE, which is referred to as an SVID, which may be an X.509 certificate or another credential. The SVID certificate is signed by a certificate authority (CA). A CA is a trusted entity that can verify the authenticity of a key certificate.

A SPIRE server is responsible for managing and issuing identities (SVIDs) in an SPIFFE trust domain for a workload identified by a SPIFFE ID. The SPIRE server stores registration information relating to conditions under which an SVID should be issued. The SPIRE server creates SVIDs when requested by authenticated SPIRE agents. The SPIFFE ID identifies a workload, while an SVID allows the workload to prove its identity.

An SVID is a relatively short-lived credential as compared to a cryptographic device identity (e.g., an IDevID certificate) used by the electronic device 102. In other words, the time interval that an SVID is valid is shorter than that of the IDevID certificate. It may be preferable to use a short-lived credential (e.g., SVID) as compared to a long-lived credential (e.g., IDevID certificate) in operations, such as attestation operations, since a compromised long-lived credential may not be easily revoked or reissued. A short-lived credential does not have to protected to the same level as a long-lived credential, so that operations involving the short-lived credential may be more efficient. After expiration of the short-lived credential, a new short-lived credential is issued, resulting in a more frequent rotation of short-lived credentials.

In other examples, instead of using SVIDs according to SPIFFE, other types of short-lived credentials can be used, such as session tokens used by Keylime attestation agents and servers, access tokens according to the OAuth 2.0 protocol used for authorization, or other types of credentials.

In accordance with some examples of the present disclosure, the attestation agent 108, the shim system 106, and the attestation server 104 can perform the following: (1) support the use of a cryptographic device identity and attestation key as part of a registration process performed by the attestation agent 108 that operates according to an open-source attestation protocol such as the Keylime protocol; (2) support an attestation workflow in which the attestation agent 108 that operates according to open-source attestation protocol can initiate an attestation of the electronic device 102 (as compared to an attestation workflow initiated by the attestation server 104); and 3) perform translations between different attestation protocols used by the attestation agent 108 in the electronic device 102 (that is to be attested) and the attestation engine 110 in the attestation server 104.

The use of the attestation agent 108 that operates according to the open-source attestation protocol allows for ease of installation of the attestation agent 108 from the open-source distribution system 112. An administrator may configure electronic devices in a computing environment to download their respective attestation agents from the open-source distribution system 112. An attestation agent may have various dependencies, e.g., the attestation agent may rely on one or more other programs for operation. The open-source distribution system 112 can automatically download any dependent program(s) to an electronic device in response to a download of an attestation agent to the electronic device. Additionally, the attestation agent or its dependent program(s) may be updated over time. The open-source distribution system 112 can support automated updates to ensure that the attestation agent remains up to date.

Additionally, an attestation workflow initiated by the attestation agent 108 is according to a push attestation model. Typically, Keylime operates according to a pull attestation model, in which an attestation server initiates the attestation workflow. For example, when an electronic device is to be verified, the attestation server sends a request, such as a Hypertext Transfer Protocol (HTTP) request to the electronic device. This means that each electronic device has to be configured to act as an HTTP server, with open ports listening for attestation requests and appropriate firewall rules. Keylime also supports an identity-provisioning feature in which the attestation server can deliver arbitrary payloads to an attestation agent for execution. This increases the attack surface and thus risk for each electronic device since the electronic device has to accept external traffic for purposes of attestation. In accordance with some examples of the present disclosure, the attestation agent 108 can avoid the foregoing issues by implementing the push attestation model. For example, the attestation agent 108 can implement a modified form of the Keylime protocol to support the push attestation model. In other examples of the present disclosure, the attestation agent 108 can additionally or alternatively implement the pull attestation model.

The TPM 120 includes a secure memory 132 to store various security information elements, which may include an IDevID key 134, an initial attestation key (IAK) 136, and an endorsement key (EK) 138, or a seed from which these keys can be recreated on demand. The TPM 120 may create further attestation keys (AKs) in addition to the IAK 136 which may be stored in the secure memory 132.

Alternatively, the further AKs may be recreated from a common seed stored in the secure memory 132. The foregoing cryptographic keys are examples of keys described in the TPM 2.0 Specification from the Trusted Computing Group (TCG).

The EK 138 was created by a manufacturer of the TPM 120 from a seed stored in the secure memory 132 of the TPM 120 at the time of manufacture of the TPM 120. The EK 138 may also be stored in the secure memory 132. At the time of manufacture of the electronic device 102 that includes the TPM 120 as a component, a manufacturer of the electronic device 102 can create the IDevID key 134 and the IAK 136 from the EK 138.

The IDevID key 134 includes an IDevID public key (referred to as IDevIDpub) and the corresponding IDevID private key (referred to as IDevIDpriv). The IAK 136 includes a public key (referred to as IAKpub or “public IAK”) and the corresponding private key (referred to as IAKpriv or “private IAK”). The IAK 136 can be used to certify that another key, such as the IDevID key 134, is held by the same TPM, in this case the TPM 120.

The manufacturer of the electronic device 102 can also create, using a CA of the manufacturer of the electronic device 102, an IDevID certificate 140 and an IAK certificate 142. A “certificate” (also referred to as a “digital certificate”) refers to information (e.g., a file or another object) that is used to prove the authenticity of an entity, such as a user, a program, or a device. A certificate may be an X.509 certificate. A certificate can include information about an entity (e.g., a user, a program, or a device), and is issued by a trusted third party, such as a CA.

Although an open-source attestation protocol such as the Keylime protocol allows ease of adoption of mechanisms that support attestations of electronic devices, some open-source attestation protocols, such as Keylime, have shortcomings in their trust model. For example, during a registration workflow, a Keylime attestation agent uses a TPM's EK and a corresponding EK certificate to register with the Keylime registrar. While the EK is unique to the TPM, the EK certificate does not contain any identifying information about the device (e.g., the electronic device 102) in which the TPM is installed, as it is intended to provide assurance as to the authenticity of the TPM. This means that any device with a genuine TPM can register itself and claim the identity of any other. In accordance with some implementations of the present disclosure, the attestation agent 108 can use the IDevID key 134 (and the corresponding IDevID certificate 140) and the IAK 136 (and the corresponding IAK certificate 142) in registering with the attestation server 104, which supports the authentication of a device identity (e.g., the device identity of the electronic device 102). The use of the IDevID key 134 and the IAK 136 can be according to a modified form of the Keylime protocol implemented by the attestation agent 108.

The DevID certificate 140 binds the IDevID key 134 to the device identity (e.g., model information and serial number) of the electronic device 102. Similarly, the IAK certificate 142 binds the IAK 136 to the device identity of the electronic device 102. Both the DevID certificate 140 and the IAK certificate 142 are X.509 public key certificates signed by the CA of the manufacturer of the electronic device 102.

After the manufacture of the electronic device 102 and deployment of the electronic device 102 in the field (e.g., in a computing environment) for use, an operator (e.g., an administrator or another entity) of the computing environment can create a local DevID (LDevID) 135 (which includes an LDevID public key and corresponding private key) and a local AK (LAK) according to TCG standards. The LAK includes a public key (referred to as LAKpub or “public LAK”) and the corresponding private key (referred to as LAKpriv or “private LAK”). An LDevID certificate and an LAK certificate can also be created in the field.

FIG. 1 shows an AK 137 stored in the secure memory 132 of the TPM 120. In some examples, the AK 137 is an LAK. In other examples, the AK 137 can be an AK generated by the attestation agent 108. In the ensuing discussion, reference is made to an AK, which can refer to an LAK or to any other type of AK. An AK certificate associated with the AK can also be created.

The IDevID certificate 140 and the IAK certificate 142 (as well as the LDevID certificate and the AK certificate) may be stored in the TPM's secure memory 132. In other examples, the certificates may be stored outside the TPM's secure memory 132 within a memory of the electronic device 102.

Note further that the TPM's secure memory 132 can also store an EK certificate (not shown) created by the TPM manufacturer. The EK certificate is signed by the TPM manufacturer and binds the EK 138 to a specific TPM, e.g., the TPM 120. While the EK 138 and the EK certificate identify the TPM 120, the IDevID certificate 140 (or LDevID certificate) and the IAK certificate 142 and AK certificate identify the electronic device 102. As noted above, the IDevID certificate 140 (or LDevID certificate) is an example of a cryptographic device identity used for authentication purposes, such as to authenticate the electronic device 102. The ensuing discussion refers to use of the IDevID certificate; similar techniques can be applied using the LDevID certificate.

In some examples, the IDevID certificate 140 includes model information (e.g., a model number) that identifies a model of the electronic device 102, and an identifier of the electronic device 102, such as a serial number or another type of identifier for uniquely identifying the electronic device 102. The model number and serial number in the IDevID certificate 140 constitute a device identity and are used to prove the authenticity of the electronic device 102.

Although reference is made to specific types of keys and associated certificates, in other examples, other types of keys and certificates can be employed. For example, instead of using the IDevID certificate 140 (or LDevID certificate) as a cryptographic device identity, a device identity provided by a Device Identifier Composition Engine (DICE) can be used as the cryptographic device identity. DICE is specified by the TCG, where the DICE is a hardware root of trust (RoT) to protect devices or components. More generally, a cryptographic device identity includes information of a device, and the cryptographic device identity is bound to the device (such as by use of a cryptographic key) to prove an authenticity of the device.

In examples where the attestation agent 108 is a Keylime attestation agent, the Keylime attestation agent is able to use other types of key certificates (e.g., IDevID certificate and IAK certificate) in addition to EK certificates. More generally, the Keylime attestation agent can use a key certificate that contains an identifier (e.g., model information and serial number) of an electronic device.

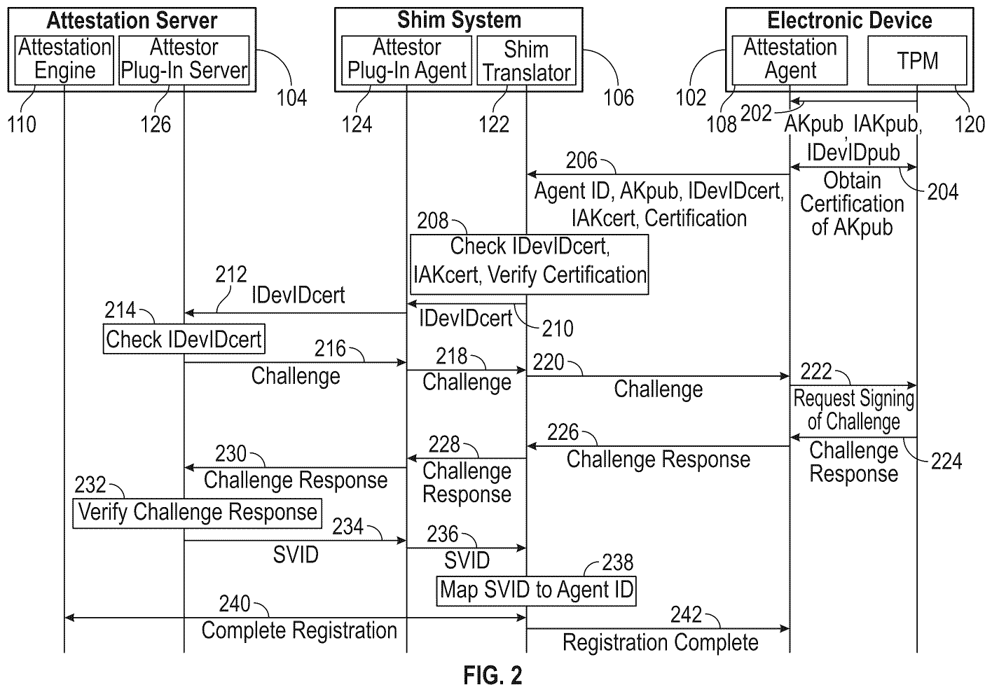

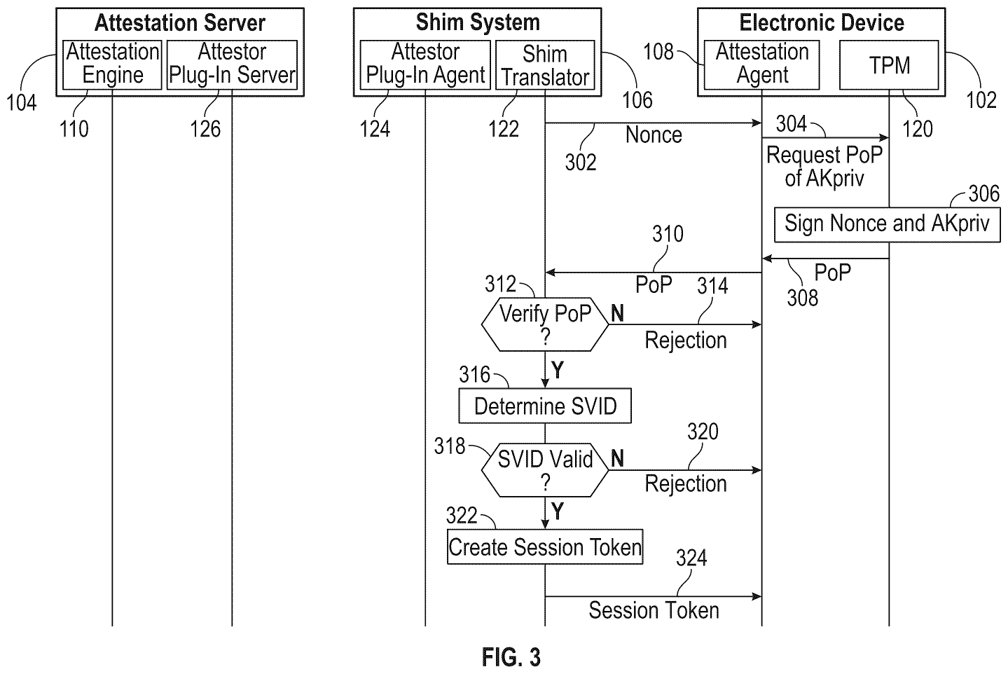

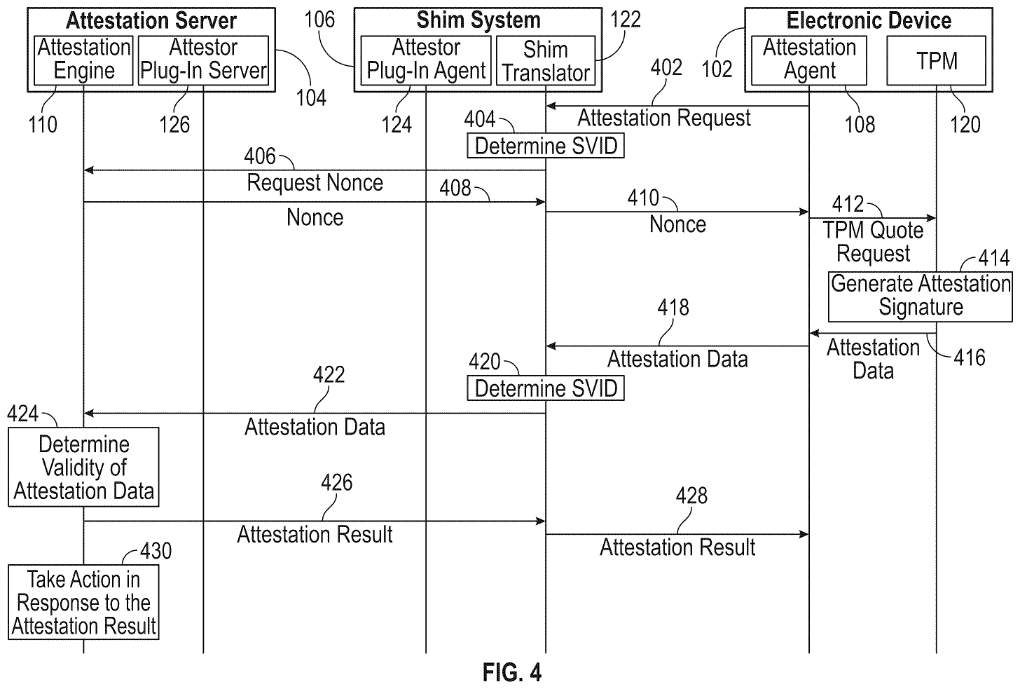

FIG. 2 is a flow diagram of a registration workflow according to some examples, for registering the electronic device 102 with the attestation server 104 so that the electronic device 102 can be subject to attestation. FIG. 3 is a flow diagram of an authentication workflow, and FIG. 4 is a flow diagram of an attestation workflow. Although each of FIGS. 2-4 shows a sequence of tasks, in other examples, the tasks may be performed in a different order, some of the tasks may be omitted, and additional tasks may be added. For example, if the attestation engine 110 operates according to the same attestation protocol as the attestation agent 116, then the shim translator 122 (and messages associated with the shim translator 122) can be omitted. In further examples, instead of using the attestor plug-in agent 124 and the attestor plug-in server 126, the functionalities of the attestor plug-in agent 124 can be included in the attestation agent 108 and/or the shim translator 122, and the functionalities of the attestor plug-in server 126 can be included in the attestation engine 110.

As further examples, the attestation engine 110 may include a Keylime registrar and verifier, in which case the shim system 106 and the attestor plug-in server 126 can be omitted. In examples where the attestation engine 110 is a Keylime registrar and verifier, tasks performed by the attestor plug-in server 126 and/or the attestation engine 110 can instead by performed by the Keylime registrar.

In each of FIGS. 2-4, messages exchanged between the shim translator 122 and the attestation agent 108 are according to a first attestation protocol, such as the Keylime protocol. Messages between the shim translator 122 and the attestation engine 110 are according to a different second attestation protocol, such as a proprietary attestation protocol, a standardized attestation protocol, or an open-source attestation protocol. Information carried in messages according to the first attestation protocol from the attestation agent 108 are extracted by the shim translator 122 and provided in messages according to the second attestation protocol to the attestation engine 110. Similarly, information carried in messages according to the second attestation protocol from the attestation engine 110 are extracted by the shim translator 122 and provided in messages according to the first attestation protocol to the attestation agent 108.

Note further that the shim translator 122 can also interact with the attestor plug-in agent 124 using a protocol supported by the attestor plug-in agent, such as the SPIFFE standards. The attestor plug-in agent 124 (and the corresponding attestor plug-in server 126) are used in the registration workflow of FIG. 2.

In the registration workflow, the TPM 120 provides (at 202) various public keys to the attestation agent 108 in the electronic device 102. The provided public keys include a public AK (AKpub), the public IAK (IAKpub) and the IDevID public key (IDevIDpub). Although the TPM 120 can share the above public keys with an entity outside the TPM 120, the corresponding private keys (e.g., a private AK, the IDevID private key, and the private IAK) remain in the TPM 120 and are not shared outside the TPM 120.

The TPM 120 can provide the public keys to the attestation agent 108 in response to a request from the attestation agent 108. If the IDevID certificate 140 and the IAK certificate 142 are also stored in the TPM's secure memory 132, the TPM 120 can also provide the key certificates to the attestation agent 108.

In some examples, the attestation agent 108 obtains (at 204) a certification by the TPM 120 of AKpub using the private IAK that is stored in the TPM 120. The attestation agent 108 can request that the TPM 120 perform the certification. A request to perform a certification can include a TPM2_Certify command, which is a command from a TPM library (not shown). The TPM2_Certify command is issued to prove that AKpub is loaded in the TPM 120. TPM commands (which may be according to the TPM 2.0 Specification from the TCG) in the TPM library are invoked to perform various TPM-related tasks, including creating keys and other operations relating to the keys. In response to the request, the TPM 120 sends a certification indication to the attestation agent 108.

In some examples, the certification indication includes a cryptographic signature based on a name representing the IAK. The cryptographic signature is produced by the TPM 120 using IAKpriv as a signature key in a signature algorithm. The cryptographic signature acts as a declaration by the TPM 120 that the TPM 120 produced the AK key. Further, the cryptographic signature provides proof that the TPM that produced the AK (public and private keys) is the same TPM that produced the IAK (public and private keys).

The attestation agent 108 requests certification of AKpub on behalf of the shim system 106. The certification provides to the shim system 106 a guarantee that AKpub was produced by a TPM, and further, that AKpub was produced by the same TPM that produced IAK.

After obtaining the certification indication from the TPM 120, the attestation agent 108 sends (at 206) the following information items to the shim translator 122: an identifier of the attestation agent 108 (referred to as an agent ID, which can be a numerical or alphanumeric value, for example), AKpub, the IDevID certificate (IDevIDcert) 140, the IAK certificate (IAKcert) 142, and the certification indication. If stored in the TPM's secure memory 132, the attestation agent 108 obtains the IDevID certificate 140 and the IAK certificate 142 from the TPM 120. Alternatively, the attestation agent 108 obtains the IDevID certificate 140 and the IAK certificate 142 from a memory outside the TPM 120.

As noted above, the IDevID certificate 140 and the IAK certificate 142 contain a device identity (e.g., model information and serial number) of the electronic device 102. An IDevID certificate binds details about the unique identity of a device stated by the manufacturer to the possession of the IDevID secret (IDevIDpriv). As such, if a device can demonstrate possession of the IDevID secret, then the device can be uniquely identified as a specific device from a specific manufacturer.

The attestation agent 108 can send the foregoing information items by calling a routine in the shim API 123 of the shim translator 122, for example. The called routine can be a routine to check (at 208) that the IDevID certificate 140 and the IAK certificate 142 are trusted. For example, the called routine of the shim API 123 can attempt to verify, using IDevIDpub and IAKpub, respectively, the signatures of the IDevID certificate 140 and the IAK certificate 142, which were signed by the CA of manufacturer of the electronic device 102. If the signatures of the IDevID certificate 140 and the IAK certificate 142 can be successfully verified, the called routine of the shim API 123 further verifies (at 208) the certification indication received from the attestation agent 108. The verification of the certification indication can be performed by calling a TPM2_Verify command of the TPM library and passing the certification indication and IAKpub as input parameters in the TPM2_Verify command. The TPM2_Verify command invokes a signature verification algorithm that is the counterpart to the signing algorithm used by the TPM 120 to produce the certification indication. If the signature verification algorithm returns a success indication (e.g., a “True” indication), this means that AKpub was produced by the same TPM which produced IAKpub (due to IAKpriv (the private IAK) and AKpriv (the private AK) being co-resident within the same TPM).

The IDevID certificate 140 and the IAK certificate 142 are trusted and the certification indication being verified provides an indication that the information elements received from the attestation agent 108 are from an authorized electronic device that has not been compromised (e.g., tampered with or loaded with malware). In response, the shim translator 122 sends (at 210) the IDevID certificate 140 to the attestor plug-in agent 124. The shim translator 122 is configured to communicate using messages supported by the attestor plug-in agent 124, which may be a SPIRE agent in some examples. The SPIRE agent communicates using messages according to the SPIFFE standards.

The attestor plug-in agent 124 forwards (at 212) the IDevID certificate 140 to the attestor plug-in server 126 at the attestation server 104. The attestor plug-in server 126, which may be a SPIRE server for example, can check (at 214) whether the IDevID certificate 140 is trusted. For example, the signature of the IDevID certificate 140 can be verified using the public key from a CA certificate.

As another example, the attestation server 104 may maintain a certificate trust store that contains all trusted certificates. This certificate trust store can store the IDevID certificate 140, for example. If the IDevID certificate 140 is in the certificate trust store, then the IDevID certificate 140 can be trusted. Alternatively, the certificate trust store can contain CA certificates. The IDevID certificate 140 can then be trusted transitively. As long as a certificate chain can be constructed from a trusted CA certificate through zero or more intermediate certificates to the IDevID certificate, the IDevID certificate is deemed trusted. In further examples, a webhook mechanism can be used to retrieve additional to determine whether the IDevID certificate 140 can be trusted. The webhook can include a uniform resource identifier (URI), which the attestor plug-in server 126 can use to obtain additional information to use in determining whether the IDevID certificate 140 can be trusted. For example, the URI may refer to a web service accessed by the attestor plug-in server 126 to obtain additional certificates to determine whether the IDevID certificate 140 can be trusted.

If the attestor plug-in server 126 determines that the IDevID certificate 140 is trusted, the attestor plug-in server 126 sends (at 216) a challenge to the attestor plug-in agent 124. The challenge can include a nonce, which is a random number generated by the attestor plug-in server 126.

In response to receiving the challenge, the attestor plug-in agent 124 sends (at 218) the challenge to the shim translator 122, which in turn forwards (at 220) the challenge to the attestation agent 108 in the electronic device 102. The shim translator 122 can communicate with the attestation agent 108 using messages according to an attestation protocol supported by the attestation agent 108, such as the Keylime protocol.

In response to receiving the challenge, the attestation agent 108 requests (at 222) the signing of the challenge using the IDevID private key (IDevIDpriv), such as by issuing a TPM2_Sign command to the TPM 120. The TPM2_Sign command is a command in the TPM library, and is to cause the TPM 120 to generate a signature of the challenge by signing the challenge using IDevIDpriv.

In response to the request, the TPM 120 sends (at 224) a challenge response to the attestation agent 108. The challenge response includes the signature of the challenge. The attestation agent 108 forwards (at 226) the challenge response to the shim translator 122, such as by calling a routine of the shim API 123. In response, the shim translator 122 sends (at 228) the challenge response to the attestor plug-in agent 124, in a message supported by the attestor plug-in agent 124.

The attestor plug-in agent 124 forwards (at 230) the challenge response to the attestor plug-in server 126. The attestor plug-in server 126 verifies (at 232) the signature of the challenge response using IDevIDpub retrieved from the IDevID certificate 140. If the signature is verified, the attestor plug-in server 126 issues an SVID and sends (at 234) the SVID (and other information) to the attestor plug-in agent 124.

In turn, the attestor plug-in agent 124 sends (at 236) the SVID to the shim translator 122, which maps (at 238) the received SVID with the agent ID of the attestation agent 108. This mapping can be accomplished by adding an entry to mapping information 150 (FIG. 1) stored in a memory 152 of the shim system 106. The mapping information 150 can be in the form of a mapping table or any other data structure with entries that map respective SVIDs to different agent IDs of attestation agents in respective electronic devices.

The shim translator 122 can also establish a secure connection with the attestation engine 110 using the SVID. The SVID is used to authenticate the attestation agent 108 to the attestation engine 110. In some examples, the secure connection is a mutual Transport Layer Security (mTLS) connection in which the entities (in this case the shim translator 122 and the attestation engine 110) connected by the mTLS connection are mutually authenticated by verifying the SVID used to establish the connection against the certificate of the SPIRE certificate authority which issued the SVID. In other examples, other types of secure connections can be established between the shim translator 122 and the attestation engine 110. A secure connection is a connection over a communication link that provides confidentiality and authentication of the transmitted data through the use of cryptographic algorithms such as encryption and signature algorithms. Note that any communication shown in FIGS. 2-4 between the shim translator 122 and the attestation engine 110 is over this secure connection.

The shim translator 122 completes (at 240) registration of the electronic device 102 with the attestation engine 110 over the secure connection. Completion of the registration of the electronic device 102 means that the attestation engine 110 has information associated with the electronic device 102 that can be used to perform attestation of the electronic device 102. For example, such information includes the IDevID certificate 140 for the electronic device 102 sent to the attestation engine 110. Also, at this point, the shim translator 122 has a mapping between the agent ID of the attestation agent 108 in the electronic device 102 and the SVID issued by the attestor plug-in server 126.

Once registration with the attestation engine 110 completes, the shim translator 122 sends (at 242), to the attestation agent 108, a registration complete indication to indicate that registration of the electronic device 102 is complete. The registration complete indication may be in the form of a message. After completion of the registration workflow shown in FIG. 2, the attestation agent 108 can proceed to perform the authentication workflow (FIG. 3) and the attestation workflow (FIG. 4).

The authentication workflow of FIG. 3 is performed to authenticate the electronic device 102. If authenticated, the attestation agent 108 in the electronic device 102 is provided with a session token. In some examples, the session token includes a string of bytes chosen at random. The session token is a temporary credential that is used for performing attestation of the electronic device 102 according to FIG. 4. In examples where the attestation agent 108 is a Keylime attestation agent, the session token is a Keylime session token.

The authentication workflow of FIG. 3 includes the attestation agent 108 obtaining (at 302) a nonce from the shim translator 122. The nonce includes a random number generated by the shim translator 122, for example. The attestation agent 108 can request the nonce from the shim translator 122.

In response to receiving the nonce, the attestation agent 108 requests (at 304) proof of possession (PoP) of AKpriv (the private AK) using the TPM2_Certify command issued to the TPM 120. The nonce and AKpub are passed as inputs to the TPM2_Certify command. The TPM 120 signs (at 306) the nonce and AKpub with AKpriv to produce a signature. This signature is an example of a representation of the PoP of AKpriv. Note that the validity of the nonce is constrained to a relatively short time interval so that a signature based on the nonce would be valid for this relatively short time interval.

The TPM 120 sends (at 308) the representation of the PoP to the attestation agent 108. The attestation agent 108 forwards (at 310) the representation of the PoP to the shim translator 122. The representation of the PoP is sent along with an agent ID of the attestation agent 108.

The shim translator 122 attempts to verify (at 312) the PoP. For example, the shim translator can issue a TPM2_Verify command with the nonce, AKpub, and the signature as inputs. If the PoP is not verified, the shim translator 122 sends (at 314), to the attestation agent 108, an authentication rejection indication to indicate that the authentication attempt failed.

However, if the PoP is verified, the shim translator 122 determines (at 316) the SVID corresponding to the agent ID of the attestation agent 108. The shim translator 122 can perform a lookup of the mapping information 150 (FIG. 1) using the agent ID to retrieve an entry corresponding to the agent ID. This entry contains the associated SVID.

The shim translator 122 determines (at 318) whether the SVID is valid. As noted above, the SVID is a relatively short-lived credential that expires after a certain time duration. If the SVID is invalid, the shim translator 122 sends (at 320), to the attestation agent 108, an authentication rejection indication to indicate that the authentication attempt failed.

However, if the SVID is valid, the shim translator 122 creates (at 322) a session token that is mapped to the agent ID of the attestation agent 108. The shim translator 122 sends (at 324) the session token to the attestation agent 108. The session token is valid for a specified time duration, and is used in the attestation workflow of FIG. 4.

In case the authentication failed that resulted in the sending of the authentication rejection (314 or 320) to the attestation agent 108, the attestation agent 108 can re-attempt the authentication process. If the authentication failed due to the SVID being invalid, each re-attempted authentication process would fail until the attestation agent 108 performs another registration workflow according to FIG. 2. Note that if verification of the PoP (at 312) failed due to an expired nonce, a re-attempted authentication process may succeed.

As noted above, the attestation protocol used by the attestation engine 110 is different from the attestation protocol used by the attestation agent 108. For purposes of performing an attestation of the electronic device 102, the shim translator 122 is able to translate between messages according to the attestation protocol used by the attestation agent 108 and the attestation protocol used by the attestation engine 110.

The attestation agent 108 initiates the attestation workflow of FIG. 4 according to the push attestation model. The attestation agent 108 sends (at 402) an attestation request, e.g., a Keylime attestation request, to the shim translator 122. The attestation request includes the agent ID of the attestation agent 108 and the session token generated in the authentication workflow of FIG. 3. The shim translator 122 is able to authenticate the attestation agent 108 that issued the attestation request using the session token.

The shim translator 122 determines (at 404), from the mapping information 150, the SVID based on the agent ID of the attestation agent 108. The shim translator 122 sends (at 406) a request for a nonce to the attestation engine 110, through a secure connection such as an mTLS connection secured using the SVID. In response, the attestation engine 110 sends (at 408) the nonce to the shim translator 122 in the secure connection. The nonce is received from the attestation engine 110 in a message according to the second attestation protocol of the attestation engine 110. The shim translator 122 sends (at 410) the nonce to the attestation agent 108 in a message according to the first attestation protocol, effectively translating between messages according to different attestation protocols used by the attestation engine 110 and the attestation agent 108.

In response to the nonce, the attestation agent 108 issues (at 412) a TPM quote request to the TPM 120. The TPM quote request includes the nonce and a key index that identifies an AK (for example an IAK or LAK) to be used in generating a signature at the TPM 120. In response to the TPM quote request, the TPM 120 retrieves values in one or more Platform Configuration Registers (PCRs) stored in the TPM 120. A PCR in a TPM is a storage location to store predefined values, such as measurements (e.g., hashes) of information (including program code such as an operating system (OS) kernel and other information) in an electronic device, such as the electronic device 102. For example, a measurement agent in the electronic device 102 can apply a cryptographic hash function, such as a Secure Hash Algorithm (SHA) function, to the information to produce a hash value that can be extended to a PCR. The measurement agent extends a PCR by performing an extend operation that calculates a cryptographic hash of a combination of the current value in PCR with a new hash value.

In response to the TPM quote request, the TPM 120 generates (at 414) an attestation signature based on the nonce and the content of the one or more PCRs. The attestation signature can be generated using a signature function, such as a Rivest-Shamir-Adleman (RSA) function.

The TPM 120 sends (at 416) attestation data in response to the TPM quote request, where the attestation data can include the content of the one or more PCRs, the attestation signature, and possibly other values. The attestation agent 108 sends (at 418) the attestation data along with the attestation agent's agent ID and the session token to the shim translator 122. The session token is used to authenticate the attestation agent 108.

The shim translator 122 determines (at 420), from the mapping information 150, the SVID based on the agent ID of the attestation agent 108. The shim translator 122 sends (at 422) the attestation data to the attestation engine 110 in a secure connection (e.g., an mTLS connection) secured using the SVID.

The attestation engine 110 determines (at 424) a validity of the attestation data. The validity of the attestation data is based on the attestation signature. If the attestation signature is invalid, then the attestation data is invalid. The attestation data is determined to be valid if the signature is valid and the content of the one or more PCRs in the attestation data is deemed correct according to a policy. The policy is defined by the attestation agent 108 and the user of the system.

The attestation engine 110 sends (at 426), over the secure connection (e.g., mTLS connection), an attestation result to the shim translator 122. The attestation result can include an attestation success or an attestation failed indication. The shim translator 122 sends (at 428) the attestation result to the attestation agent 108. In further examples, the shim translator 122 does not send the attestation result to the attestation agent 108.

The attestation engine 110 can take action (at 430) in response to the attestation result produced by the attestation engine 110. If the attestation result includes an attestation success indication, the attestation engine 110 allows operation of the electronic device 102 to proceed normally. However, if the attestation result includes an attestation failed indication, the attestation engine 110 can trigger a remediation action, such as by sending the attestation result to another system that can perform any of the following: shut down or otherwise disable the electronic device 102, disable a network connection, send an alert, or any other remediation action.

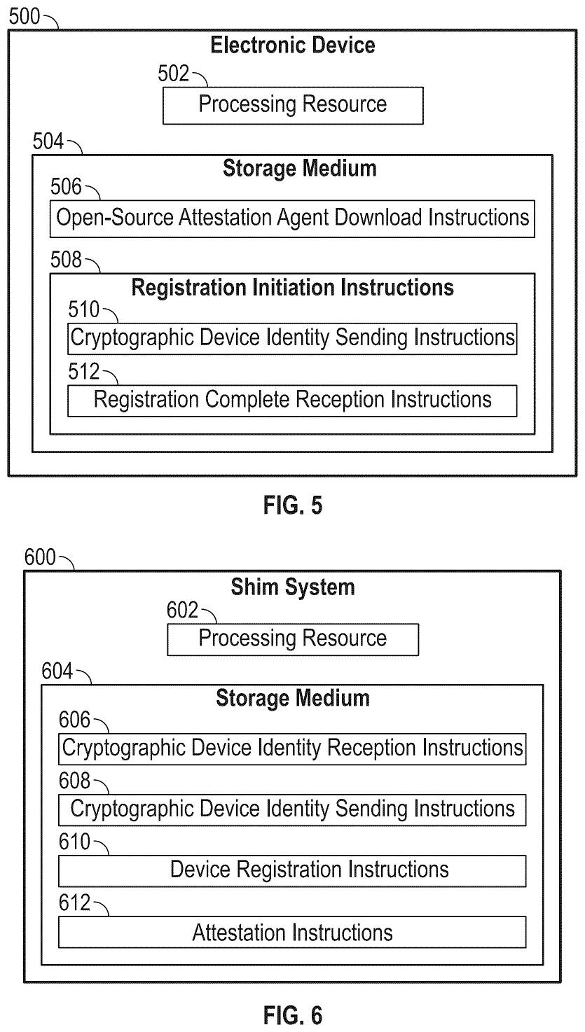

FIG. 5 is a block diagram of an electronic device 500. An example of the electronic device 500 is the electronic device 102 of FIG. 1. Examples of electronic devices can include any or some combination of the following: a desktop computer, a notebook computer, a tablet computer, a server computer, a smartphone, a game appliance, a household appliance, a communication node such as a network switch, a storage system, a vehicle, or any other type of electronic device.

The electronic device 500 includes a processing resource 502, which includes one or more hardware processors. A hardware processor can include a microprocessor, a core of a multi-core microprocessor, a microcontroller, a programmable integrated circuit, a programmable gate array, or another hardware processing circuit.

The electronic device 500 further includes a storage medium 504 storing machine-readable instructions executable by the processing resource 502. The machine-readable instructions may be executable on a hardware processor of the processing resource 502. Machine-readable instructions executable on a hardware processor can refer to the instructions executable on a single hardware processor or the instructions executable on multiple hardware processors.

The machine-readable instructions include open-source attestation agent download instructions 506 to download an attestation agent from an open-source distribution system. An example of the open-source distribution system is the open-source distribution system 112 of FIG. 1.

The machine-readable instructions include registration initiation instructions 508 to initiate a registration process of the electronic device with an attestation server. An example of the registration process is the registration workflow of FIG. 2. An example of the attestation server is the attestation server 104 of FIG. 1. The registration initiation instructions 508 include cryptographic device identity sending instructions 510 to send, by the attestation agent in the electronic device, a cryptographic device identity for receipt by the attestation server. An example of the cryptographic device identity is an IDevID certificate, an LDevID certificate, or another type of cryptographic device identity. The cryptographic device identity may be sent by the attestation agent to a shim system, such as the shim system 106 of FIG. 1. In other examples, the cryptographic device identity may be sent by the attestation agent to the attestation server without passing through any shim system.

The registration initiation instructions 508 include registration complete reception instructions 512 to receive, by the attestation agent, an indication of registration of the electronic device based on the attestation server verifying the cryptographic device identity. The indication of registration may be received by the attestation agent from the shim system, or alternatively, from the attestation server without passing through any shim system.

In some examples, the registration process includes receiving, by the attestation agent, a challenge sent by the attestation server responsive to the attestation server verifying the cryptographic device identity. For example, in FIG. 2, the shim system sends (at 220) the challenge generated by the attestation server 104 to the attestation agent 108. The registration process further includes sending, by the attestation agent for receipt by the attestation server, a challenge response signed with a private key of the cryptographic device identity to produce a signature. For example, in FIG. 2, the attestation agent 108 sends (at 226) a challenge response to the shim system 106. In an example, the cryptographic device identity can include a DevID certificate, such as an IDevID certificate or an LDevID certificate, and the private key can include a DevID private key, such as an IDevID private key or an LDevID private key. The challenge may be received by the attestation agent from the shim system, or alternatively, from the attestation server without passing through any shim system. The challenge response may be sent by the attestation agent to the shim system, or alternatively, to the attestation server without passing through any shim system.

In some examples, the indication of registration is based on verification of the signature by the attestation server.

In some examples, the electronic device 500 further includes a security processor, such as the TPM 120 of FIG. 1. The attestation agent obtains the cryptographic device identity from the security processor.

In some examples, the registration process further includes sending, by the attestation agent, an IAK certificate and a DevID certificate for verification that the DevID certificate can be trusted. For example, in FIG. 2, the attestation agent 108 sends (at 206) IDevIDcert and IAKcert to the shim system 106.

In some examples, the registration process further includes the attestation agent requesting a certification of a public AK by a security processor, such as task 204 in FIG. 2. The attestation agent receives a certification indication from the security processor based on the security processor certifying the public AK, and the attestation agent sends the certification indication (e.g., task 206 in FIG. 2) to verify that the public AK is from the security processor that provided the IAK.

In some examples, the verification of the certification indication allows use of the DevID certificate in completing the registration process.

In some examples, the IAK certificate, the DevID certificate, and the certification indication are sent from the attestation agent in the electronic device to a shim system including a translator to translate between a first attestation protocol used by the attestation agent and a second attestation protocol used by the attestation server.

In some examples, a security processor in the electronic device stores an AK, such as an IAK and/or an LAK. As part of an authentication process (e.g., the authentication workflow of FIG. 3), the attestation agent can request (e.g., task 304 of FIG. 3) signing of specified information provided by the shim system using a private AK by the security processor. For example, the specified information can include a nonce from the shim system. The attestation agent receives, from the security processor, a signature produced by the signing (e.g., task 308 in FIG. 3). The attestation agent sends the signature to the shim system to authenticate the electronic device (e.g., task 310 in FIG. 3).

In some examples, the attestation agent receives a session token from the shim system based on the shim system verifying the signature (e.g., task 324 in FIG. 3). The attestation agent uses the session token in performing an attestation of the electronic device, e.g., as part of the attestation workflow of FIG. 4.

In some examples, the attestation agent obtains attestation data from the security processor (e.g., task 416 in FIG. 4), the attestation data being based on a measurement of information in the electronic device. The attestation agent sends the attestation data for receipt by the attestation server for attestation of the electronic device (e.g., task 418 in FIG. 4).

In some examples, the machine-readable instructions in the electronic device can update the attestation agent using a patch process provided by the open-source distribution system.

FIG. 6 is a block diagram of a shim system 600 according to some examples. An example of the shim system 600 is the shim system 106 of FIG. 1.

The shim system 600 includes a processing resource 602, and a storage medium 604 storing machine-readable instructions executable on a processor of the processing resource 602 to perform various tasks.

The machine-readable instructions in the storage medium 604 include cryptographic device identity reception instructions 606 to receive, from an attestation agent operating according to a first attestation protocol in the electronic device, a cryptographic device identity. For example, in FIG. 2, the attestation agent 108 sends (at 206) the IDevID certificate to the shim system 106.

The machine-readable instructions in the storage medium 604 include cryptographic device identity sending instructions 608 to, based on verifying that the cryptographic device identity can be trusted, send the cryptographic device identity from the shim system to an attestation server including an attestation engine that operates according to a second attestation protocol different from the first attestation protocol. For example, in FIG. 2, the shim system 106 sends (at 210) IDevIDcert to the attestation server 104.

The machine-readable instructions in the storage medium 604 include device registration instructions 610 to register the electronic device with the attestation server. For example, in FIG. 2, the shim system 106 completes registration (at 240) with the attestation server 104.

The machine-readable instructions in the storage medium 604 include attestation instructions 612 to, after the registering, perform an attestation of the electronic device in which the shim system translates between a message according to the first attestation protocol and a message according to the second attestation protocol. The attestation can be according to the attestation workflow of FIG. 4, for example.

In some examples, the shim system receives, from the attestation server, a cryptographic machine identity that has a shorter validity time interval than the cryptographic device identity. An example of the cryptographic machine identity is an SVID. The shim system uses the cryptographic machine identity to establish a secure connection between the shim system and the attestation engine through which attestation data is communicated.

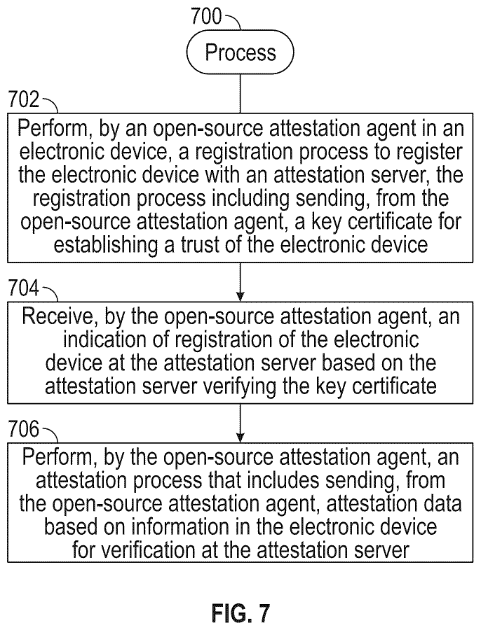

FIG. 7 is a flow diagram of a process 700 according to some examples of the present disclosure. The process 700 includes performing (at 702), by an open-source attestation agent in an electronic device, a registration process to register the electronic device with an attestation server, the registration process including sending, from the open-source attestation agent, a key certificate for establishing a trust of the electronic device. The key certificate includes a device identity of the electronic device. The key certificate may include an IDevID certificate or an LDevID certificate, for example.

The process 700 includes receiving (at 704), by the open-source attestation agent, an indication of registration of the electronic device at the attestation server based on the attestation server verifying the key certificate. For example, once the registration of the electronic device is completed with the attestation engine 110 of FIG. 1, the shim system 106 can send a registration complete indication to the attestation agent 108 (task 242 in FIG. 2).

The process 700 includes performing (at 706), by the open-source attestation agent, an attestation process that includes sending, from the open-source attestation agent, attestation data based on information in the electronic device for verification at the attestation server. For example, the attestation data may be obtained from a TPM or another security processor.

In some examples, the process 700 includes receiving, at the open-source attestation agent, an attestation result produced by the attestation server based on the attestation data as part of the verification. In other examples, the open-source attestation agent does not receive the attestation result.

As used here, a “message” can be in the form of a data packet or any other unit of data, an information element, or any type of indicator. A “memory” can be implemented with one or more memory devices, such as a dynamic random access memory (DRAM) device, a static random access memory (SRAM) device, an erasable and programmable read-only memory (EPROM), an electrically erasable and programmable read-only memory (EEPROM), a flash memory device, or another type of memory device). A “storage subsystem” can be implemented with one or more storage devices, such as a disk-based storage device, a solid-state drive, or another type of storage device. A “network” can refer to any communication medium, such as a local area network (LAN), a wide area network (WAN), the Internet, or any other type of network.

A non-transitory machine-readable or computer-readable storage medium (e.g., 504 in FIG. 5 or 604 in FIG. 6) can include any or some combination of the following: a memory, a storage subsystem, or any other type of storage. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. An electronic device comprising:
a processor; and
a non-transitory storage medium comprising instructions executable on the processor to:
download an attestation agent from an open-source distribution system;
initiate a registration process of the electronic device with an attestation server, the registration process comprising:
sending, by the attestation agent in the electronic device, a cryptographic device identity for receipt by the attestation server,
receiving, by the attestation agent, an indication of registration of the electronic device based on the attestation server verifying the cryptographic device identity.

2. The electronic device of claim 1, wherein the registration process comprises:
receiving, by the attestation agent, a challenge sent by the attestation server responsive to the attestation server verifying the cryptographic device identity, and
sending, by the attestation agent for receipt by the attestation server, a challenge response signed with a private key of the cryptographic device identity to produce a signature.

3. The electronic device of claim 2, wherein the indication of registration is based on verification of the signature by the attestation server.

4. The electronic device of claim 2, wherein the cryptographic device identity comprises a Device Identity (DevID) certificate, and the private key comprises a DevID private key.

5. The electronic device of claim 1, further comprising a security processor,
wherein the attestation agent is to obtain the cryptographic device identity from the security processor.

6. The electronic device of claim 1, wherein the registration process further comprises:
sending, by the attestation agent, an initial attestation key (IAK) certificate and a Device Identity (DevID) certificate for verification that the DevID certificate can be trusted.

7. The electronic device of claim 6, wherein the registration process further comprises:
requesting, by the attestation agent, a certification of a public AK by a security processor; and
receiving, by the attestation agent, a certification indication from the security processor based on the security processor certifying the public AK; and
sending, by the attestation agent, the certification indication to verify that the public AK is from the security processor that provided the IAK.

8. The electronic device of claim 7, wherein the verification of the certification indication allows use of the DevID certificate in completing the registration process.

9. The electronic device of claim 7, wherein the IAK certificate, the DevID certificate, and the certification indication are sent from the attestation agent in the electronic device to a shim system comprising a translator to translate between a first attestation protocol used by the attestation agent and a second attestation protocol used by the attestation server.

10. The electronic device of claim 1, wherein the cryptographic device identity is sent by the attestation agent to a shim system comprising a translator to translate between a first attestation protocol used by the attestation agent and a second attestation protocol used by the attestation server, and wherein the indication of registration is received by the attestation agent from the shim system.

11. The electronic device of claim 10, further comprising:
a security processor to store an attestation key (AK),
wherein the instructions are executable on the processor to:
request, by the attestation agent, signing of specified information provided by the shim system using a private AK;
receive, by the attestation agent, a signature produced by the signing; and
send, from the attestation agent, the signature to the shim system to authenticate the electronic device.

12. The electronic device of claim 11, wherein the instructions are executable on the processor to:
receive, at the attestation agent, a session token from the shim system based on the shim system verifying the signature; and
use the session token in performing an attestation of the electronic device.

13. The electronic device of claim 12, wherein the instructions are executable on the processor to:
obtain, by the attestation agent, attestation data from the security processor, the attestation data based on a measurement of information in the electronic device; and
send, by the attestation agent, the attestation data for receipt by the attestation server for attestation of the electronic device.

14. The electronic device of claim 11, wherein the signature provides a proof of possession of the AK private key.

15. The electronic device of claim 1, wherein the instructions are executable on the processor to:
update the attestation agent using a patch process provided by the open-source distribution system.

16. A shim system comprising:
a processor; and
a non-transitory storage medium storing instructions executable on the processor to:
receive, from an attestation agent operating according to a first attestation protocol in an electronic device, a cryptographic device identity;
based on verifying that the cryptographic device identity can be trusted, send the cryptographic device identity from the shim system to an attestation server comprising an attestation engine that operates according to a second attestation protocol different from the first attestation protocol;
register the electronic device with the attestation server; and
after the registering, perform an attestation of the electronic device in which the shim system translates between a message according to the first attestation protocol and a message according to the second attestation protocol.

17. The shim system of claim 16, wherein the instructions are executable on the processor to:
receive, at the shim system from the attestation server, a cryptographic machine identity that has a shorter validity time interval than the cryptographic device identity; and
use the cryptographic machine identity to establish a secure connection between the shim system and the attestation engine through which attestation data is communicated.

18. The shim system of claim 17, further comprising:
a memory to store mapping information that maps an identifier of the attestation agent to the cryptographic machine identity issued by the attestation server.

19. A method comprising:
performing, by an open-source attestation agent in an electronic device, a registration process to register the electronic device with an attestation server, the registration process comprising sending, from the open-source attestation agent, a key certificate for establishing a trust of the electronic device, the key certificate comprising a device identity of the electronic device;
receiving, by the open-source attestation agent, an indication of registration of the electronic device at the attestation server based on the attestation server verifying the key certificate; and
performing, by the open-source attestation agent, an attestation process that comprises sending, from the open-source attestation agent, attestation data based on information in the electronic device for verification at the attestation server.

20. The method of claim 19, wherein:
the key certificate is sent from the open-source attestation agent to a shim system comprising a translator to translate between a first attestation protocol used by the open-source attestation agent and a second attestation protocol used by the attestation server,
the indication of registration is received by the open-source attestation agent from the shim system, and
the attestation data is sent from the open-source attestation agent to the shim system.
